(19) United States
(12) Patent Application Publication
(10) Pub. No.: US 2009/0147616 A1
(43) Pub. Date: Jun. 11, 2009

(54) Method of and Apparatus For Controlling The Efficiency of Mixing

(76) Inventor: Kimmo Leinonen, Kotka (FI)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/223,016

(22) PCT Filed: Jan. 12, 2007
(86) PCT No.: PCT/EP2007/050294

§ 371 Date: Dec. 5, 2008

(30) Foreign Application Priority Data
Jan. 30, 2006 (EP) 06405044.6

(51) Int. Cl. B01F 15/00

(52) U.S. Cl. 366/142

(57) ABSTRACT

A method of and apparatus for controlling the efficiency of mixing of a mixer, comprising injecting a chemical into a process fluid flowing in a pipe, mixing the chemical with the process fluid with a mixer operating at a first operation rate, wherein the method comprises further steps of measuring an efficiency of mixing of the chemical and the process fluid within the pipe downstream of the mixer, comparing the measured efficiency of mixing with a predetermined efficiency of mixing range, controlling the operation rate of the mixer so as to adjust the efficiency of mixing to the predetermined efficiency of mixing range. The efficiency of mixing is preferably measured by using a set of electrodes disposed on the periphery of the pipe, and the efficiency of mixing is preferably obtained by the use of electrical impedance tomography.

The present invention relates to a method of and apparatus for controlling the efficiency of mixing of a mixer for mixing two fluids, especially a chemical into a process fluid. The method and apparatus according to the invention are especially suitable for use in connection with a mixer used for mixing a gaseous or liquid chemical into a medium consistency process fluid in chemical and mechanical wood processing industry, but the invention is, of course, also suitable for use in other corresponding applications.

Many industrial processes, for example in pulp and paper industry, use a variety of chemicals to be mixed with a stock, such as a pulp stock. To avoid chemical waste, many process plants, for example pulp mills, remove water from the stock, which then becomes thicker, such as so-called medium consistency pulp, which is defined as fiber/air/water suspension where the dry solids content is between 8 and 18%, and may resist attempts to mix with chemicals. Chemicals which may be mixed with pulp stock include, for example, oxygen, steam, peroxide, peracetic acid, chlorine dioxide and ozone. To promote mixing of the chemicals with the stock, mechanical or static mixers are often used to disperse the chemicals.

Efficient mixing of chemicals and stock is very important, because good mixing maximizes the contact area between the chemicals and the stock and thereby reduces the need for excessive use of chemicals. An optimized use of chemicals improves the process control and product quality and reduces the environmental load. Manufactured or purchased chemicals often significantly increase the cost of the process, and reduction in the consumption of chemicals may lead to considerable economical savings.

On the other hand, mixers consume energy, which is taken either from the motor of a mechanical mixer, or, in case of a static mixer, from the fluid flow. The consumed energy represents power loss, which decreases the overall energy efficiency of the process. Therefore, it is also important to avoid too intensive mixing, i.e. mixing which does not any more increase the homogeneity of the end fluid, or improves the homogeneity only marginally.

The efficiency of mixing can be quantified by different quantities, such as mixing index M, which is defined as the standard deviation of a measured quantity divided by its mean value, or mixing effectiveness E defined as

E=100*(1−M)%.

In order to adjust mixing to an optimum level, the efficiency of mixing should be measured on-line downstream the mixer. Tests for mixing index can be conducted in laboratory by different means, for example by using ultraviolet tracer materials which are measured by a fiber optic probe at the mixer discharge where the distribution and standard deviation can be measured and displayed. However, laboratory test methods, such as tests by ultraviolet tracer materials, are usually difficult to conduct at a process plant, and thus they are of limited value to the operators of process plants.

A method used for quantifying mixing of a low temperature chemical with medium consistency pulp stream at a higher temperature is based on profiling temperatures at the outlet of a mixer by thermocouple arrays positioned on the surface of the discharge pipe. Improperly mixed chemical will show up as a cold spot at one measurement while another point would be too hot, not having any cold chemical mixed with it. This method monitors the mixing of the components only in the vicinity of the surface of the pipe. The usability of the method is also limited due to its inaccuracy based on, e.g., the thermal time constants of the components of the system.

An object of the present invention is to provide a method of and an apparatus for measuring the efficiency of mixing of a mixer so as to control the efficiency of mixing of the mixer.

Another object of the present invention is to provide a method of and an apparatus for controlling the efficiency of mixing of a mixer so as to simultaneously guarantee sufficient efficiency of mixing and avoid too intensive mixing.

In order to achieve these and other objects of the present invention, a method is provided, as described in the accompanying claims. Especially, according to the present invention, a method of controlling the efficiency of mixing of a mixer is provided, the method comprising the steps of: injecting a chemical into a process fluid flowing in a pipe; mixing the chemical with the process fluid with a mixer operating at a first operation rate; measuring an efficiency of mixing of the chemical and the fluid within the pipe downstream of the mixer; comparing the measured efficiency of mixing with a predetermined range of efficiency of mixing and controlling the operation rate of the mixer so as to adjust the efficiency of mixing to the predetermined range of efficiency of mixing.

Additionally, according to the present invention, an apparatus for mixing a chemical into a process fluid having a controllable efficiency of mixing is provided, the apparatus comprising means such as an injector for injecting the chemical into the process fluid flowing in a pipe, a mixer for mixing the chemical with the process fluid, means such as a measuring apparatus for measuring an efficiency of mixing of the chemical and the process fluid within the pipe downstream of the mixer, and means such as a controller for controlling the operation rate of the mixer on the basis of the measured efficiency of mixing.

The efficiency of mixing the chemical with the process fluid within the pipe down-stream the mixer is advantageously measured by using a set of electrodes disposed on the periphery of the pipe. The electrodes are preferably spaced regularly around the pipe. According to a preferred embodiment of the present invention, the efficiency of mixing of the fluids is measured by one of the known electrical impedance tomography (EIT) sensing techniques, which provide an image of the fluids in a full cross section of the pipe.

Electrical impedance tomography is non-intrusive, of high temporal resolution and low cost, it does not cause radiation and is easy to implement. Electrical impedance tomography can be, e.g., electrical resistance tomography or electrical capacitance tomography. The actual method to be chosen mainly depends on the physical properties of the fluids to be measured. Electrical resistance tomography is mostly suitable for situations including a continuous electrically conducting phase, and electric capacitance tomography for processes involving insulating mixtures of different permittivities. The most versatile electrical tomography is true electrical impedance tomography which is based on the phase-sensitive detection principle, where the resistive component is detected by the in-phase measurement and the capacitive component is detected by the quadrature-phase measurement.

A flow imaging system based on capacitive electrical impedance tomography has been described in U.S. Pat. No. 5,130,661. When applying electrical capacitance tomography, the capacitances formed by different pairs of capacitance electrodes positioned around a pipe are measured. The U.S. Pat. No. 5,130,661 also describes a back projection algorithm for processing the measured capacitance data to calculate an image of the material distribution of within a pipe. Generally electrical capacitance tomography can be used to observe the distribution of permittivity ε, within a vessel. The number of electrodes must be high enough to obtain the required spatial resolution, but not too high in order to be able to process the data at the required temporal resolution.

The principles of resistive electrical impedance tomography have been described, for example, in U.S. Pat. No. 5,807,251. When applying electrical impedance tomography to monitor distribution of electrical resistivity ρ of material within a pipe, a plurality of electrodes are mounted at spaced locations of the wall of the pipe. The electrodes are electrically insulated from one another and arranged to be in electrical contact with the material in the pipe. An input electrical signal, usually an excitation current signal, may be applied between an electrical reference ground and each electrode, separately, and respective output electrical signals, usually voltage signals, are generated between the reference ground and each other one of the electrodes. The output signals are measured and processed to provide a representation of the distribution of material, or actually, electrical resistivity ρ or conductivity σ=1/ρ in a cross section of the pipe.

In case where the wall of the pipe is made of electrically conductive material, the wall itself may advantageously be made to serve as the reference ground relative to which the input and output electrical signals are applied and measured. The electrodes mounted on the wall are in this case electrically insulated from the wall, and protruding through it into contact with the material in the pipe. If the wall of the pipe is non-conductive, other means of providing the reference ground must be devised. For example, an electrically conductive component positioned within the pipe may be made to serve as the reference ground electrode.

The electrical signals may be obtained also by infecting current between pairs of electrodes, and measuring voltages from the same electrodes, or, as is more usual, to measure induced voltages between other pairs of electrodes. According to a so called neighboring method, the currents are injected between neighboring electrodes, and voltages are measured between other pairs of electrodes. This method, however, has a reduced sensitivity at the center of the pipe, and therefore, the currents are more usually injected between opposite electrodes or between electrodes located at another specified distance from each others.

Usually electrical impedance tomography is based on the use of an array of electrodes arranged around a pipe or vessel, and the assumption that the electrical excitations are confined to the two dimensional plane of the electrodes. However, in principle it is also possible to use a three dimensional approach where, on the basis of data obtained from electrodes positioned in multiple planes, a three dimensional distribution of fluids is obtained.

There are several known algorithms for reconstructing a tomographic image from the measured electrical signals. These methods include, for example, so-called backprojection method, sensitivity coefficient method, iterative method, variational method and perturbation method. Any of these methods can be used for obtaining the values of conductivity σ or permittivity ε in each cell of the reconstructed image.

According to a preferred embodiment of the present invention, the efficiency of mixing is quantified as the mixing effectiveness E

E=(1−M)*100%,

where M is the mixing index

M=S/<A_{N}>,

and S is the standard deviation of the quantities A_{N}, obtained from the electrical signals of the electrodes disposed on the periphery of the pipe, and <A_{N}> is the mean value of A_{N}. The quantities A_{N} can be the conductivity values σ or permittivity values ε of individual cells, filled with the mixture of fluids, of a tomographic image formed on the basis of the measured electrical signals.

According to an alternative, more simple solution, which is especially suitable when the cross section of the pipe is completely filled with the fluids, the values A_{N} are values Aᵢⱼ obtained from the electrical signals of different pairs of electrodes Lᵢ, Lⱼ, without forming an actual tomographic image. The values Aᵢⱼ can be determined, for example, as a function f of the differences of electrical signals, as follows

Aᵢⱼ=f(Sᵢⱼ−Sᵢⱼ⁰),

where the electrical signal Sᵢⱼ can be, for example, a capacitance value observed between electrodes Lᵢ and Lⱼ, or a voltage observed between electrode Lⱼ and ground when a current pulse is injected between electrode Lᵢ and ground, and Sᵢⱼ⁰ is a corresponding signal for a pipe filled with a homogenous mixture of corresponding fluids. An advantageous method for calculating target variables, such as mixing index, without image reconstruction, based on a statistical inverse approach by using Bayesian neural networks, is proposed by Lampinen, J. Vehtari, A. and Leinonen K. (1999) in Proceedings of 11^{th} Scandinavian Conference on Image Analysis SCIA '99, Kangerlussuaq, Greenland.

According to a preferred embodiment of the present invention, the operation rate of the mixer is adjusted so as to have the measured efficiency of mixing within a pre-determined range. Usually it is required that the efficiency of mixing is above a certain minimum efficiency of mixing, determined by a suitable quantity, such as a minimum mixing effectiveness Eₘᵢₙ. Thereby, the operation rate of the mixer is increased by a predetermined small amount, if the measured mixing effectiveness E is below the minimum mixing effectiveness Eₘᵢₙ.

On the other hand, while unnecessarily high operation rate of the mixer causes excess loss of power, it is useful to avoid too high operation rate. In cases where the efficiency of mixing is a monotonous function of the operation rate of the mixer, excess power consumption can be avoided simply by determining a maximum efficiency of mixing, for example by a maximum mixing effectiveness Eₘₐₓ, which should not be exceeded. Thereby, the operation rate of the mixer is decreased by a predetermined small amount, if the mixing effectiveness E is above the maximum mixing effectiveness Eₘₐₓ.

However, it may happen that, due to relatively low resolution of the determination of the mixing effectiveness, it is not possible to define a useful measurable maximum mixing effectiveness Eₘₐₓ. In such cases the loss of power can be minimized by reducing the operation rate of the mixer by a predetermined small amount when the minimum mixing effectiveness Eₘᵢₙ has been exceeded for a certain predetermined time, whereby possible continuous unnecessarily high mixing is avoided.

It is also possible that the efficiency of mixing is not a monotonous function of the operation rate of the mixer, but it levels off at a certain operation rate or has a maximum and is again reduced at operation rates higher than a certain value. Such a behaviour can be observed by an apparatus in accordance with the present invention, and the operation rate of the mixer can be optimized correspondingly.

According to a preferred embodiment of the present invention, the operation rate of the mixer is controlled by adjusting the rotation rate or blade angle of a rotor of a mechanical mixer. If the mixer is a static mixer, the operation rate of the mixer can be controlled by adjusting the angle or position of a mixing promoting element, such as a flow obstruction element or a rib, of the mixer.

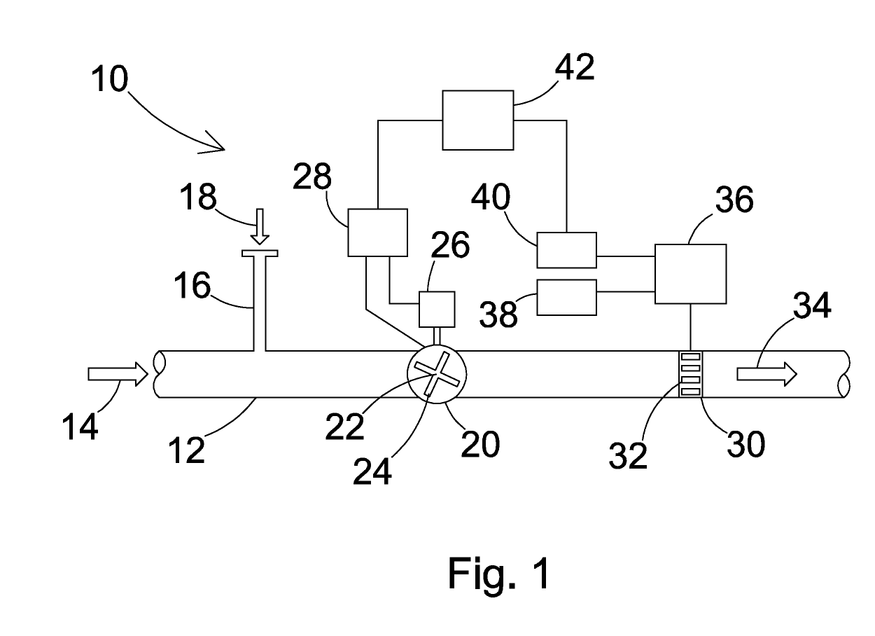

In the following, the method and apparatus according to the invention are described in more detail, with reference to the appended drawing, FIG. 1, which illustrates an apparatus according to a preferred embodiment of the invention.

FIG. 1 shows an apparatus 10 according to a preferred embodiment of the invention, the apparatus comprising a pipe 12, where a first stream 14 of a process fluid is flowing, and means 16 for injecting a stream 18 of a chemical into the process fluid. The chemical is mixed with the process fluid with a mechanical mixer 20, comprising a rotor 22 with mixing blades 24 and a motor 26 for rotating the rotor 22. The operation rate of the mixer can be controlled by a controller 28, which controls the rotation speed of the rotor 22 of the mixer 20. Additionally or alternatively, the blade angle of the mixing blades 24 may be controllable, and the controller 28 may be designed to control the blade angle of the mixing blades 24.

A set of electrodes 30 is preferable disposed regularly around the wall 32 of the pipe 12, downstream the mixer 20. The number of electrodes is usually at least eight, but it may be larger, such as twelve or sixteen. The electrodes 30 may be mounted inside the pipe wall 30 to be in contact with the mixed stream 34, or, when a capacitance measurement is used, within or outside the wall 32, to be in vicinity of the stream 34. The electrodes have usually an extended sensing area to increase the electrical signal obtained by the electrodes, but in some applications it may be useful to use electrodes with relatively small sensing areas.

The electrodes 32 are advantageously connected to a multiplexer 36, a current source 38 and a voltmeter 40, whereby current pulses can be injected between selected electrodes, and voltages can be measured between the same electrodes or between selected other electrodes. According to an alternative solution, the injected pulses are voltages and measured signals are current pulses. The injected pulses can also be injected between selected electrodes and a ground, whereby the measured pulses can be measured between selected other electrodes and a ground.

The measured signals, usually measured voltages, are transmitted to a device, usually a computer 42 for calculating the efficiency of mixing of the mixer 20. The computer 42 may be used for calculating a tomographic image of the distribution of conductivity ρ or permittivity in the mixed stream 34 by using a known image reconstruction algorithm. Alternatively, the efficiency of mixing can be inferred from the measured electrical signals by using an alternative algorithm, such as an algorithm based on using neural networks, without forming a full tomographic image.

The computer 42 is connected to the controller 28, so as to control the operation rate of the mixer 20 on the basis of the measured efficiency of mixing. According to a preferred embodiment of the invention, a desired range of efficiency of mixing is inputted to the computer 42, and the operation rate of the mixer 20 is controlled so as to keep the efficiency of mixing of the mixer 20 within the desired range of efficiency of mixing. The desired range of mixing comprises preferably a lower limit, and the operation rate of the mixer is increased by a small amount, if the measured efficiency of mixing is below the lower limit. The desired range of mixing comprises advantageously also an upper limit, and the operation rate of the mixer 20 is increased by a small amount if the measured efficiency of mixing is above the upper limit.

In some cases, the accuracy of the measurement may be so low that it is not possible to define a separate upper limit for the desired range of efficiency of mixing. Especially in such cases it may be useful to adjust the control process of the mixer so that if the measured efficiency of mixing has been above the desired lower limit for a certain time, the operation rate of the mixer is again reduced by a small amount. Thereby it is assured that excessive amounts of energy are not lost due to too high operation rate of the mixer.

In some applications the efficiency of mixing is not a monotonous function of the operation rate of the mixer, but has a maximum at a certain operation rate and de creases again with higher operation rates. In order to avoid consuming excess energy due to such behaviour, it is advantageous that data on the performance characteristics of the mixer is stored to the computer 42, and the control of the mixer is made by taking into account such characteristics. For example, if the efficiency of mixing is decreased while the operation rate of the mixer is increased, it is advisable to continue by immediately decreasing the operation rate. Correspondingly, if the efficiency of mixing is increased while the operation rate of the mixer is decreased, it is advisable to continue by still decreasing the operation rate

In the FIG. 1 the mixer is shown as a mechanical mixer including a motor for rotating a rotor. According to an alternative embodiment of the invention, the mixer can be a static mixer having adjustable mixing promoting elements, such as ribs or obstruction plates. The present invention can be applied to a static mixer by controlling the angle or position of the mixing promoting elements on the basis of a measured efficiency of mixing, as described above in connection with the embodiment shown in FIG. 1.

It should be noted from the above disclosure that the invention has only been described with reference to a few exemplary solutions. These solutions are not intended as limiting the invention to only the above-mentioned details, but the invention is limited only by the appended claims and the definitions therein.

1. A method of controlling the efficiency of mixing of a mixer, the method comprising the steps of:
a) injecting a chemical into a process fluid,
b) mixing the chemical with the process fluid with a mixer operating at a first operation rate characterized in that the method comprises further steps of
c) measuring an efficiency of mixing of the chemical and the fluid downstream of the mixer,
d) comparing the measured efficiency of mixing with a predetermined range of efficiency of mixing, and
e) controlling the operation rate of the mixer so as to adjust the efficiency of mixing to the predetermined range of efficiency of mixing.

2. A method according to claim 1, characterized in that in step c) the efficiency of mixing is measured by using a set of electrodes disposed on the periphery of a pipe or container arranged downstream of the mixer.

3. A method according to claim 2, characterized in that the set of electrodes is used in electrical impedance tomography.

4. A method according to claim 3, characterized in that the method comprises a step of calculating a conductivity or permittivity distribution of the process fluid.

5. A method according to claim 2, characterized in that the method comprises a step of calculating the efficiency of mixing without reconstructing a tomographic image.

6. A method according to claim 5, characterized in that the efficiency of mixing is calculated by a method based on using neural networks.

7. A method according to claim 1, characterized in that in step e) the operation rate of the mixer is controlled by adjusting the rotation rate or a blade angle of a rotor of the mixer.

8. A method according to claim 1, characterized in that the mixer is a static mixer, and in step e) the operation rate of the mixer is controlled by adjusting a mixing promoting element of the mixer.

9. A method according to claim 1, characterized in that the predetermined range of efficiency of mixing comprises a lower limit, and in step e) the operation rate of the mixer is increased if the measured efficiency of mixing is below the lower limit.

10. A method according to claim 9, characterized in that the predetermined range of efficiency of mixing comprises an upper limit, and in step e) the operation rate of the mixer is decreased if the measured efficiency of mixing is above the upper limit.

11. A method according to claim 9, characterized in that the operation rate of the mixer is decreased if the efficiency of mixing is above the lower limit continuously for a predetermined time.

12. A method according to claim 1, characterized in that the chemical is injected upstream of the mixer into the process fluid flowing in a pipe.

13. A method according to claim 1, characterized in that the fluid is medium consistency pulp.

14. An apparatus for mixing a chemical into a process fluid having a controllable efficiency of mixing, the apparatus comprising:
an injector and/or an injecting connection for injecting the chemical into the process fluid,
a mixer for mixing the chemical with the process fluid
characterized in that the apparatus comprises
a measuring apparatus capable of determining an efficiency of mixing of the chemical and the process fluid downstream of the mixer,
a controller connected to the measuring apparatus and the mixer for controlling the operation rate of the mixer on the basis of the measured efficiency of mixing.

15. An apparatus according to claim 14, characterized in that the apparatus comprises a pipe or container arranged downstream of the mixer and in that the measuring apparatus comprises a set of electrodes disposed on the periphery of the pipe or container.

16. An apparatus according to claim 15, characterized in that the measuring apparatus comprises means for producing a tomographic image of the distribution of conductivity or permittivity within the pipe or container.

17. An apparatus according to claim 14, characterized in that the controller comprises means for adjusting the rotation rate or a blade angle of a rotor of the mixer.

18. An apparatus according to claim 14, characterized in that the mixer is a static mixer, the controller comprises means for adjusting a mixing promoting element of the mixer.

19. An apparatus according to claim 14, characterized in that the mixer is for mixing gaseous or liquid chemical with medium consistency pulp.
